(19) United States
(12) Patent Application Publication
(10) Pub. No.: US 2022/0132567 A1
(43) Pub. Date: Apr. 28, 2022

(54) METHOD OF TRANSMITTING/RECEIVING DATA UNIT, AND DEVICE AND STORAGE MEDIUM THEREFOR

(71) Applicant: LG Electronics Inc., Seoul (KR)

(72) Inventors: Eunjong LEE, Seoul (KR); Sunghoon JUNG, Seoul (KR); Jeonggu LEE, Seoul (KR); Sunyoung LEE, Seoul (KR); Jayeong KIM, Seoul (KR)

(21) Appl. No.: 17/427,448

(22) PCT Filed: Feb. 3, 2020
(86) PCT No.: PCT/KR2020/001566

§ 371 Date: Jul. 30, 2021

(30) Foreign Application Priority Data
Feb. 1, 2019 (KR) 10-2019-0014004
Feb. 1, 2019 (KR) 10-2019-0014033
Feb. 1, 2019 (KR) 10-2019-0014038

(51) Int. Cl. H04W 74/08; H04W 72/14

(52) U.S. Cl. CPC H04W 74/0808; H04W 72/14

(57) ABSTRACT

In the present disclosure, a user equipment (UE) receives a uplink (UL) grant for a wide band, the wide band i) being wider than a predetermined value, ii) operating on an unlicensed band and iii) including multiple subbands; measures channel occupancy for the wide band; determines whether to generate a medium access control (MAC) protocol data unit (PDU) in units of the whole wide band or in units of subband, based on the measured channel occupancy; generates the MAC PDU in units of the whole wide band or in units of subband; performs clear channel assessment (CCA) per subband; and transmits the generated MAC PDU via at least one subband where the CCA is successful.

### TECHNICAL FIELD

The present invention relates to a wireless communication system.

### BACKGROUND ART

Introduction of new radio communication technologies has led to increases in the number of user equipments (UEs) to which a base station (BS) provides services in a prescribed resource region, and has also led to increases in the amount of data and control information that the BS transmits to the UEs. Due to typically limited resources available to the BS for communication with the UE(s), new techniques are needed by which the BS utilizes the limited radio resources to efficiently receive/transmit uplink/downlink data and/or uplink/downlink control information.

### DISCLOSURE OF INVENTION

### Technical Problem

Various types of signals, including data signals and control signals, are communicated via the UL and DL. Scheduling of such communications is typically performed, to achieve improved efficiency, latency, and/or reliability. Overcoming delay or latency has become an important challenge in applications whose performance critically depends on delay/latency.

The technical objects that can be achieved through the present invention are not limited to what has been particularly described hereinabove and other technical objects not described herein will be more clearly understood by persons skilled in the art from the following detailed description.

### Solution to Problem

As an aspect of the present disclosure, provided herein is a method for transmitting a data unit by a user equipment (UE) in a wireless communication system. The method comprises: receiving a uplink (UL) grant for a wide band, the wide band i) being wider than a predetermined value, ii) operating on an unlicensed band and iii) including multiple subbands; measuring channel occupancy for the wide band; determining whether to generate a medium access control (MAC) protocol data unit (PDU) in units of the whole wide band or in units of subband, based on the measured channel occupancy; generating the MAC PDU in units of the whole wide band or in units of subband; performing clear channel assessment (CCA) per subband; and transmitting the generated MAC PDU via at least one subband where the CCA is successful.

As another aspect of the present disclosure, provided herein is a user equipment (UE) of transmitting a data unit in a wireless communication system. The UE comprises: at least one transceiver; at least one processor; and at least one computer memory that is operably connectable to the at least one processor and that stores instructions that, when executed, cause the at least one processor to perform operations. The operations comprise: receiving a uplink (UL) grant for a wide band, the wide band i) being wider than a predetermined value, ii) operating on an unlicensed band and iii) including multiple subbands; measuring channel occupancy for the wide band; determining whether to generate a medium access control (MAC) protocol data unit (PDU) in units of the whole wide band or in units of subband, based on the measured channel occupancy; generating the MAC PDU in units of the whole wide band or in units of subband; performing clear channel assessment (CCA) per subband; and transmitting the generated MAC PDU via at least one subband where the CCA is successful.

As a further aspect of the present disclosure, provided herein is an apparatus. The apparatus comprise: at least one processor; and at least one computer memory that is operably connectable to the at least one processor and that stores instructions that, when executed, cause the at least one processor to perform operations. The operations comprise: receiving a uplink (UL) grant for a wide band, the wide band i) being wider than a predetermined value, ii) operating on an unlicensed band and iii) including multiple subbands; measuring channel occupancy for the wide band; determining whether to generate a medium access control (MAC) protocol data unit (PDU) in units of the whole wide band or in units of subband, based on the measured channel occupancy; generating the MAC PDU in units of the whole wide band or in units of subband; performing clear channel assessment (CCA) per subband; and transmitting the generated MAC PDU via at least one subband where the CCA is successful.

As a still further aspect of the present disclosure, provided herein is a computer readable storage medium that stores at least one program that, when executed, causes at least one processor to perform operations. The operations comprise: receiving a uplink (UL) grant for a wide band, the wide band i) being wider than a predetermined value, ii) operating on an unlicensed band and iii) including multiple subbands; measuring channel occupancy for the wide band; determining whether to generate a medium access control (MAC) protocol data unit (PDU) in units of the whole wide band or in units of subband, based on the measured channel occupancy; generating the MAC PDU in units of the whole wide band or in units of subband; performing clear channel assessment (CCA) per subband; and transmitting the generated MAC PDU via at least one subband where the CCA is successful.

In each aspect pf the present disclosure, the UE may generate the MAC PDU in units of the whole wide band based on the measured channel occupancy being below a first threshold value. The UE may generate the MAC PDU in units of subband based on the measured channel occupancy being above the threshold value.

In each aspect of the present disclosure, the UE may receive information regarding the first threshold value.

In each aspect of the present disclosure, the UE may determine whether to transmit the generated MAC PDU, based on (i) generating the MAC PDU in units of the whole wide band and (ii) the CCA being successful for only some of the multiple subbands. The UE may transmit the generated MAC PDU, only when the CCA is successful for the whole wide band, based on the measured channel occupancy being below a second threshold value. The UE may transmit the generated MAC PDU, when the CCA is successful for at least one subband among the multiple subbands, based on the measured channel occupancy being below the second threshold value.

In each aspect of the present disclosure, the UE may receive information regarding the second threshold value.

As a still further aspect of the present disclosure, provided herein is a method for transmitting a data unit by a user equipment (UE) in a wireless communication system. The method comprises: receiving a uplink (UL) grant for a wide band, the wide band i) being wider than a predetermined value, ii) operating on an unlicensed band and iii) including multiple subbands; measuring channel occupancy for the wide band; determining a transmission rule for transmitting UL data among a plurality of transmission rules, based on the measured channel occupancy; and transmitting the UL data according to the determined rule. The plurality of rules may comprise: i) a first transmission rule that the UE transmits the UL data, only when clear channel assessment (CCA) is successful for the whole wide band, and ii) a second transmission rule that the UE transmits the UL data, when CCA is successful for at least one subband among the multiple subbands.

As a still further aspect of the present disclosure, provided herein is a user equipment (UE) of transmitting a data unit in a wireless communication system. The UE comprises: at least one transceiver; at least one processor; and at least one computer memory that is operably connectable to the at least one processor and that stores instructions that, when executed, cause the at least one processor to perform operations. The operations comprise: receiving a uplink (UL) grant for a wide band, the wide band i) being wider than a predetermined value, ii) operating on an unlicensed band and iii) including multiple subbands; measuring channel occupancy for the wide band; determining a transmission rule for transmitting UL data among a plurality of transmission rules, based on the measured channel occupancy; and transmitting the UL data according to the determined rule. The plurality of rules may comprise: i) a first transmission rule that the UE transmits the UL data, only when clear channel assessment (CCA) is successful for the whole wide band, and ii) a second transmission rule that the UE transmits the UL data, when CCA is successful for at least one subband among the multiple subbands.

As a still further aspect of the present disclosure, provided herein is an apparatus. The apparatus comprises: at least one processor; and at least one computer memory that is operably connectable to the at least one processor and that stores instructions that, when executed, cause the at least one processor to perform operations comprising: receiving a uplink (UL) grant for a wide band, the wide band i) being wider than a predetermined value, ii) operating on an unlicensed band and iii) including multiple subbands; measuring channel occupancy for the wide band; determining a transmission rule for transmitting UL data among a plurality of transmission rules, based on the measured channel occupancy; and transmitting the UL data according to the determined rule. The plurality of rules may comprise: i) a first transmission rule that the UE transmits the UL data, only when clear channel assessment (CCA) is successful for the whole wide band, and ii) a second transmission rule that the UE transmits the UL data, when CCA is successful for at least one subband among the multiple subbands.

As a still further aspect of the present disclosure, provided herein is a computer readable storage medium that stores at least one program that, when executed, causes at least one processor to perform operations. The operations comprise: receiving a uplink (UL) grant for a wide band, the wide band i) being wider than a predetermined value, ii) operating on an unlicensed band and iii) including multiple subbands; measuring channel occupancy for the wide band; determining a transmission rule for transmitting UL data among a plurality of transmission rules, based on the measured channel occupancy; and transmitting the UL data according to the determined rule. The plurality of rules may comprise: i) a first transmission rule that the UE transmits the UL data, only when clear channel assessment (CCA) is successful for the whole wide band, and ii) a second transmission rule that the UE transmits the UL data, when CCA is successful for at least one subband among the multiple subbands.

In each aspect of the present disclosure, the UE may transmit the UL data on the wide band according to the first transmission rule, based on the measured channel occupancy being below a first threshold value.

In each aspect of the present disclosure, the UE may transmit the UL data on the one or more subband only, according to the second transmission rule, based on the measured channel occupancy being above the first threshold value.

In each aspect of the present disclosure, the UE may generate a medium access control (MAC) protocol data unit (PDU) including the UL data. The UE may generate the MAC PDU in units of the whole wide band based on the measured channel occupancy being below a second threshold value. The UE may generate the MAC PDU in units of subband based on the measured channel occupancy based on above the second threshold value.

In each aspect of the present disclosure, the UE may receive information regarding the second threshold value.

In each aspect of the present disclosure, the UE may randomly select one of subbands for which CCA is successful, based on the measured channel occupancy being above the first threshold value. The UE may transmit the UL data on the selected subband only.

### Advantageous Effects of Invention

In some scenarios, implementations of the present disclosure may provide one or more of the following advantages. In some scenarios, radio communication signals can be more efficiently transmitted and/or received. Therefore, overall throughput of a radio communication system can be improved.

According to some implementations of the present disclosure, delay/latency occurring during communication between a user equipment and a BS may be reduced.

Also, signals in a new radio access technology system can be transmitted and/or received more effectively.

It will be appreciated by persons skilled in the art that the effects that can be achieved through the present disclosure are not limited to what has been particularly described hereinabove and other advantages of the present disclosure will be more clearly understood from the following detailed description.

### BRIEF DESCRIPTION OF DRAWINGS

The accompanying drawings, which are included to provide a further understanding of the invention, illustrate embodiments of the invention and together with the description serve to explain the principle of the invention:

FIG. 1 illustrates an example of a communication system 1 to which implementations of the present disclosure is applied;

FIG. 2 is a block diagram illustrating examples of communication devices which can perform a method according to the present disclosure;

FIG. 3 illustrates another example of a wireless device which can perform implementations of the present invention;

FIG. 4 illustrates an example of protocol stacks in a third generation partnership project (3GPP) based wireless communication system;

FIG. 5 illustrates an example of a frame structure in a 3GPP based wireless communication system;

FIG. 6 illustrates a data flow example in the 3GPP new radio (NR) system;

FIG. 7 illustrates an example of physical downlink shared channel (PDSCH) time domain resource allocation by physical downlink control channel (PDCCH), and an example of physical uplink shared channel (PUSCH) time resource allocation by PDCCH;

FIG. 8 illustrates examples of options related to bandwidth part (BWP) operation in unlicensed bands;

FIG. 9 to FIG. 13 illustrate examples of generating MAC PDU or TB according to some transmission schemes;

FIG. 14 illustrates an example of a flow diagram for data transmission in unlicensed bands according to some implementations of the present disclosure;

FIG. 15 illustrates another example of a flow diagram for data transmission in unlicensed bands according to some implementations of the present disclosure;

FIG. 16 illustrates an example of UE/network behavior according to some implementations of the present disclosure;

FIG. 17 illustrates another example of UE/network behavior according to some implementations of the present disclosure; and

FIG. 18 illustrates an example of physical layer processing for some implementations of the present disclosure.

### MODE FOR THE INVENTION

Reference will now be made in detail to the exemplary implementations of the present disclosure, examples of which are illustrated in the accompanying drawings. The detailed description, which will be given below with reference to the accompanying drawings, is intended to explain exemplary implementations of the present disclosure, rather than to show the only implementations that can be implemented according to the disclosure. The following detailed description includes specific details in order to provide a thorough understanding of the present disclosure. However, it will be apparent to those skilled in the art that the present disclosure may be practiced without such specific details.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced. For example, the following documents may be referenced.

3GPP LTE
3GPP TS 36.211: Physical channels and modulation
3GPP TS 36.212: Multiplexing and channel coding
3GPP TS 36.213: Physical layer procedures
3GPP TS 36.214: Physical layer; Measurements
3GPP TS 36.300: Overall description
3GPP TS 36.304: User Equipment (UE) procedures in idle mode
3GPP TS 36.314: Layer 2—Measurements
3GPP TS 36.321: Medium Access Control (MAC) protocol
3GPP TS 36.322: Radio Link Control (RLC) protocol
3GPP TS 36.323: Packet Data Convergence Protocol (PDCP)
3GPP TS 36.331: Radio Resource Control (RRC) protocol

3GPP NR (e.g. 5G)
3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: Overall description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description

In the present disclosure, a user equipment (UE) may be a fixed or mobile device. Examples of the UE include various devices that transmit and receive user data and/or various kinds of control information to and from a base station (BS). In the present disclosure, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. Especially, a BS of the UMTS is referred to as a NB, a BS of the enhanced packet core (EPC)/long term evolution (LTE) system is referred to as an eNB, and a BS of the new radio (NR) system is referred to as a gNB.

In the present disclosure, a node refers to a point capable of transmitting/receiving a radio signal through communication with a UE. Various types of BSs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be a BS. For example, the node may be a radio remote head (RRH) or a radio remote unit (RRU). The RRH or RRU generally has a lower power level than a power level of a BS. Since the RRH or RRU (hereinafter, RRH/RRU) is generally connected to the BS through a dedicated line such as an optical cable, cooperative communication between RRH/RRU and the BS can be smoothly performed in comparison with cooperative communication between BSs connected by a radio line. At least one antenna is installed per node. The antenna may include a physical antenna or an antenna port or a virtual antenna.

In the present disclosure, the term “cell” may refer to a geographic area to which one or more nodes provide a communication system, or refer to radio resources. A “cell” of a geographic area may be understood as coverage within which a node can provide service using a carrier and a “cell” as radio resources (e.g. time-frequency resources) is associated with bandwidth (BW) which is a frequency range configured by the carrier. The “cell” associated with the radio resources is defined by a combination of downlink resources and uplink resources, for example, a combination of a downlink (DL) component carrier (CC) and an uplink (UL) CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In the present disclosure, a physical downlink control channel (PDCCH), and a physical downlink shared channel (PDSCH) refer to a set of time-frequency resources or resource elements (REs) carrying downlink control information (DCI), and a set of time-frequency resources or REs carrying downlink data, respectively. In addition, a physical uplink control channel (PUCCH), a physical uplink shared channel (PUSCH) and a physical random access channel (PRACH) refer to a set of time-frequency resources or REs carrying uplink control information (UCI), a set of time-frequency resources or REs carrying uplink data and a set of time-frequency resources or REs carrying random access signals, respectively.

In the present disclosure, the term “cell” may refer to a geographic area to which one or more nodes provide a communication system, or refer to radio resources. A “cell” of a geographic area may be understood as coverage within which a node can provide service using a carrier and a “cell” as radio resources (e.g. time-frequency resources) is associated with bandwidth (BW) which is a frequency range configured by the carrier. The “cell” associated with the radio resources is defined by a combination of downlink resources and uplink resources, for example, a combination of a downlink (DL) component carrier (CC) and a uplink (UL) CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In carrier aggregation (CA), two or more CCs are aggregated. A UE may simultaneously receive or transmit on one or multiple CCs depending on its capabilities. CA is supported for both contiguous and non-contiguous CCs. When CA is configured the UE only has one radio resource control (RRC) connection with the network. At RRC connection establishment/re-establishment/handover, one serving cell provides the non-access stratum (NAS) mobility information, and at RRC connection reestablishment/handover, one serving cell provides the security input. This cell is referred to as the Primary Cell (PCell). The PCell is a cell, operating on the primary frequency, in which the UE either performs the initial connection establishment procedure or initiates the connection re-establishment procedure. Depending on UE capabilities, Secondary Cells (SCells) can be configured to form together with the PCell a set of serving cells. An SCell is a cell providing additional radio resources on top of Special Cell. The configured set of serving cells for a UE therefore always consists of one PCell and one or more SCells. In the present disclosure, for dual connectivity (DC) operation, the term “special Cell” refers to the PCell of the master cell group (MCG) or the PSCell of the secondary cell group (SCG), and otherwise the term Special Cell refers to the PCell. An SpCell supports physical uplink control channel (PUCCH) transmission and contention-based random access, and is always activated. The MCG is a group of serving cells associated with a master node, comprising of the SpCell (PCell) and optionally one or more SCells. The SCG is the subset of serving cells associated with a secondary node, comprising of the PSCell and zero or more SCells, for a UE configured with DC. For a UE in RRC_CONNECTED not configured with CA/DC there is only one serving cell comprising of the PCell. For a UE in RRC_CONNECTED configured with CA/DC the term “serving cells” is used to denote the set of cells comprising of the SpCell(s) and all SCells.

The MCG is a group of serving cells associated with a master BS which terminates at least S1-MME, and the SCG is a group of serving cells associated with a secondary BS that is providing additional radio resources for the UE but is not the master BS. The SCG includes a primary SCell (PSCell) and optionally one or more SCells. In DC, two MAC entities are configured in the UE: one for the MCG and one for the SCG. Each MAC entity is configured by RRC with a serving cell supporting PUCCH transmission and contention based Random Access. In the present disclosure, the term SpCell refers to such cell, whereas the term SCell refers to other serving cells. The term SpCell either refers to the PCell of the MCG or the PSCell of the SCG depending on if the MAC entity is associated to the MCG or the SCG, respectively.

In the present disclosure, monitoring a channel refers to attempting to decode the channel. For example, monitoring a physical downlink control channel (PDCCH) refers to attempting to decode PDCCH(s) (or PDCCH candidates).

In the present disclosure, “C-RNTI” refers to a cell RNTI, “SI-RNTI” refers to a system information RNTI, “P-RNTI” refers to a paging RNTI, “RA-RNTI” refers to a random access RNTI, “SC-RNTI” refers to a single cell RNTI″, “SL-RNTI” refers to a sidelink RNTI, “SPS C-RNTI” refers to a semi-persistent scheduling C-RNTI, and “CS-RNTI”refers to a configured scheduling RNTI.

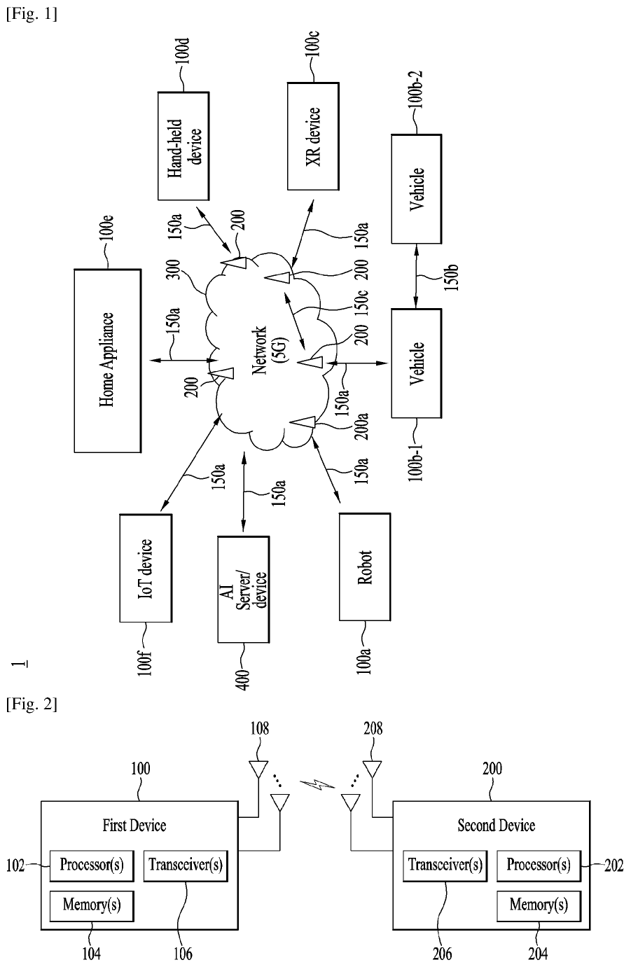

FIG. 1 illustrates an example of a communication system 1 to which implementations of the present disclosure is applied.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential IoT devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g. e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices, base stations (BSs), and a network. Although FIG. 1 illustrates a 5G network as an example of the network of the communication system 1, the implementations of the present disclosure are not limited to the 5G system, and can be applied to the future communication system beyond the 5G system.

The BSs and the network may be implemented as wireless devices and a specific wireless device 200a may operate as a BS/network node with respect to other wireless devices.

The wireless devices represent devices performing communication using radio access technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A user equipment (UE) may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an unmanned aerial vehicle (UAV), an artificial intelligence (AI) module, a robot, an augmented reality (AR) device, a virtual reality (VR) device, a mixed reality (MR) device, a hologram device, a public safety device, an MTC device, an IoT device, a medical device, a FinTech device (or a financial device), a security device, a weather/environment device, a device related to a 5G service, or a device related to a fourth industrial revolution field. The unmanned aerial vehicle (UAV) may be, for example, an aircraft aviated by a wireless control signal without a human being onboard. The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet. The public safety device may include, for example, an image relay device or an image device that is wearable on the body of a user. The MTC device and the IoT device may be, for example, devices that do not require direct human intervention or manipulation. For example, the MTC device and the IoT device may include smartmeters, vending machines, thermometers, smartbulbs, door locks, or various sensors. The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure. The security device may be, for example, a device installed to prevent a danger that may arise and to maintain safety. For example, the security device may be a camera, a CCTV, a recorder, or a black box. The FinTech device may be, for example, a device capable of providing a financial service such as mobile payment. For example, the FinTech device may include a payment device or a point of sales (POS) system. The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a and 150b may be established between the wireless devices 100a to 100f/BS 200-BS 200. Herein, the wireless communication/connections may be established through various RATs (e.g., 5G NR) such as uplink/downlink communication 150a and sidelink communication 150b (or D2D communication). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 2 is a block diagram illustrating examples of communication devices which can perform a method according to the present disclosure.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to {the wireless device 100a to 100f and the BS 200} and/or {the wireless device 100a to 100f and the wireless device 100a to 100f} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the functions, procedures, and/or methods described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the procedures and/or methods described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present invention, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the functions, procedures, and/or methods described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the procedures and/or methods described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present invention, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the functions, procedures, proposals, and/or methods disclosed in the present disclosure. The one or more processors 102 and 202 may generate messages, control information, data, or information according to the functions, procedures, proposals, and/or methods disclosed in the present disclosure. The one or more processors 102 and 202 may generate signals (e.g., baseband signals) including PDUs, SDUs, messages, control information, data, or information according to the functions, procedures, proposals, and/or methods disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the functions, procedures, proposals, and/or methods disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The functions, procedures, proposals, and/or methods disclosed in the present disclosure may be implemented using firmware or software and the firmware or software may be configured to include the modules, procedures, or functions. Firmware or software configured to perform the functions, procedures, proposals, and/or methods disclosed in the present disclosure may be included in the one or more processors 102 and 202 or stored in the one or more memories 104 and 204 so as to be driven by the one or more processors 102 and 202. The functions, procedures, proposals, and/or methods disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of the present disclosure, to one or more other devices. The one or more transceivers 106 and 206 may receive user data, control information, and/or radio signals/channels, mentioned in the functions, procedures, proposals, methods, and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the functions, procedures, proposals, methods, and/or operational flowcharts disclosed in the present disclosure, through the one or more antennas 108 and 208. In the present disclosure, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the present disclosure, at least one memory (e.g. 104 or 204) may store instructions or programs that, when executed, cause at least one processor, which is operably connected thereto, to perform operations according to some embodiments or implementations of the present disclosure.

In the present disclosure, a computer readable storage medium may store at least one instruction or computer program that, when executed by at least one processor, causes the at least one processor to perform operations according to some embodiments or implementations of the present disclosure.

In the present disclosure, a processing device or apparatus may comprise at least one processor, and at least one computer memory connectable to the at least one processor and storing instructions that, when executed, cause the at least one processor to perform operations according to some embodiments or implementations of the present disclosure.

In some implementations of the present disclosure, a UE may operate as a transmitting device in uplink (UL) and as a receiving device in downlink (DL). In some implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS, unless otherwise mentioned or described. For example, the processor(s) 102 connected to, mounted on or launched in the first wireless device 100 may be configured to perform the UE behaviour according to an implementation of the present disclosure or control the transceiver(s) 106 to perform the UE behaviour according to an implementation of the present disclosure. The processor(s) 202 connected to, mounted on or launched in the second wireless device 200 may be configured to perform the BS behaviour according to an implementation of the present disclosure or control the transceiver(s) 206 to perform the BS behaviour according to an implementation of the present disclosure.

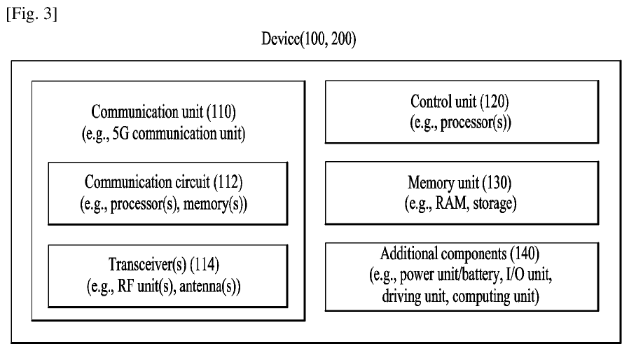

FIG. 3 illustrates another example of a wireless device which can perform implementations of the present invention. The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit (e.g. audio I/O port, video I/O port), a driving unit, and a computing unit. The wireless device may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a Fintech device (or a finance device), a security device, a climate/environment device, the AI server/device (400 of FIG. 1), the BSs (200 of FIG. 1), a network node, etc. The wireless device may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a random access memory (RAM), a dynamic RAM (DRAM), a read only memory (ROM)), a flash memory, a volatile memory, a non-volatile memory, and/or a combination thereof.

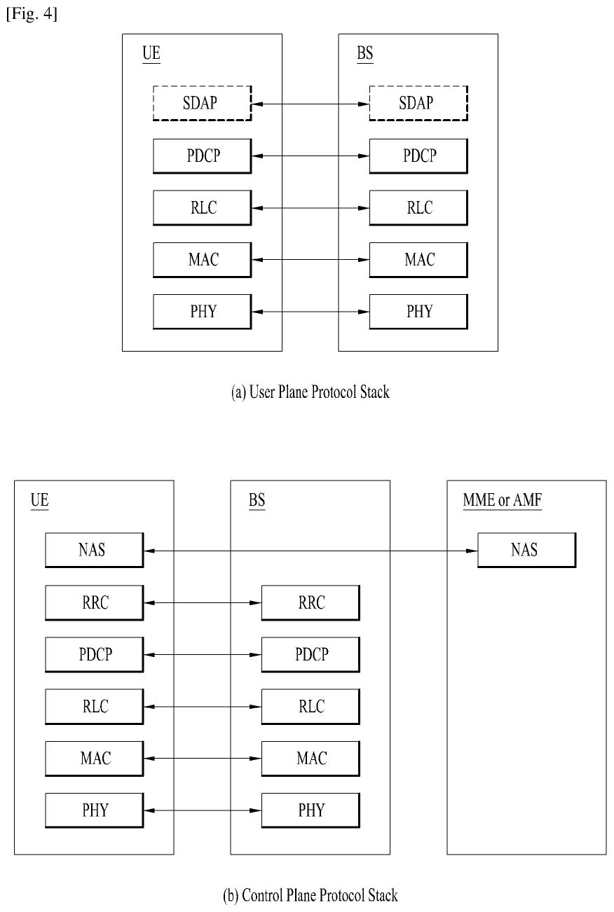

FIG. 4 illustrates an example of protocol stacks in a 3GPP based wireless communication system.

In particular, FIG. 4(a) illustrates an example of a radio interface user plane protocol stack between a UE and a base station (BS) and FIG. 4(b) illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4(a), the user plane protocol stack may be divided into a first layer (Layer 1) (i.e., a physical (PHY) layer) and a second layer (Layer 2). Referring to FIG. 4(b), the control plane protocol stack may be divided into Layer 1 (i.e., a PHY layer), Layer 2, Layer 3 (e.g., a radio resource control (RRC) layer), and a non-access stratum (NAS) layer. Layer 1, Layer 2 and Layer 3 are referred to as an access stratum (AS).

The NAS control protocol is terminated in an access management function (AMF) on the network side, and performs functions such as authentication, mobility management, security control and etc.

In the 3GPP LTE system, the layer 2 is split into the following sublayers: medium access control (MAC), radio link control (RLC), and packet data convergence protocol (PDCP). In the 3GPP New Radio (NR) system, the layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G Core Network quality of service (QoS) flows.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G core (5GC) or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer; UE cell selection and reselection and control of cell selection and reselection; Inter-RAT mobility); QoS management functions; UE measurement reporting and control of the reporting; detection of and recovery from radio link failure; NAS message transfer to/from NAS from/to UE.

In the 3GPP NR system, the main services and functions of the PDCP sublayer for the user plane include: sequence numbering; header compression and decompression: ROHC only; transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

The RLC sublayer supports three transmission modes: Transparent Mode (TM); Unacknowledged Mode (UM); and Acknowledged Mode (AM). The RLC configuration is per logical channel with no dependency on numerologies and/or transmission durations. In the 3GPP NR system, the main services and functions of the RLC sublayer depend on the transmission mode and include: Transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the MAC sublayer include: mapping between logical channels and transport channels; multiplexing/demultiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use. Different kinds of data transfer services are offered by MAC. To accommodate different kinds of data transfer services, multiple types of logical channels are defined i.e. each supporting transfer of a particular type of information. Each logical channel type is defined by what type of information is transferred. Logical channels are classified into two groups: Control Channels and Traffic Channels. Control channels are used for the transfer of control plane information only, and traffic channels are used for the transfer of user plane information only. Broadcast Control Channel (BCCH) is a downlink logical channel for broadcasting system control information, paging Control Channel (PCCH) is a downlink logical channel that transfers paging information, system information change notifications and indications of ongoing PWS broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In Downlink, the following connections between logical channels and transport channels exist: BCCH can be mapped to BCH; BCCH can be mapped to downlink shared channel (DL-SCH); PCCH can be mapped to PCH; CCCH can be mapped to DL-SCH; DCCH can be mapped to DL-SCH; and DTCH can be mapped to DL-SCH. In Uplink, the following connections between logical channels and transport channels exist: CCCH can be mapped to uplink shared channel (UL-SCH); DCCH can be mapped to UL-SCH; and DTCH can be mapped to UL-SCH.

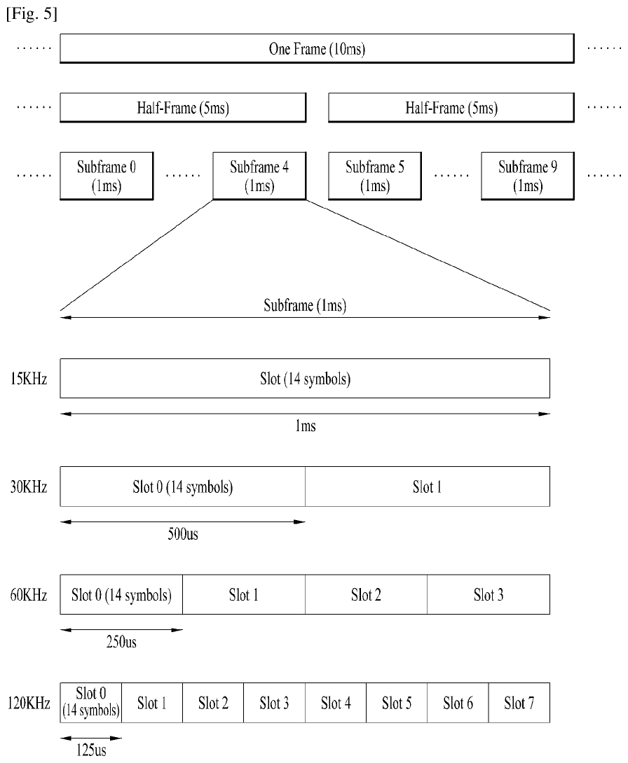

FIG. 5 illustrates an example of a frame structure in a 3GPP based wireless communication system.

The frame structure illustrated in FIG. 5 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g. a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 5, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz. The following table shows the number of OFDM symbols per slot, the number of slots per frame, and the number of slots per for the normal CP, according to the subcarrier spacing Δf=2^{u}*15 kHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

The following table shows the number of OFDM symbols per slot, the number of slots per frame, and the number of slots per for the extended CP, according to the subcarrier spacing Δf=2^{u}*15 kHz.

TABLE 2

| u | N^{slot}_{symb} | N^{frame, u}ₛₗₒₜ | Ns^{ubframe, u}ₛₗₒₜ |
|---|---|---|---|
| 2 | 12 | 40 | 4 |

A slot includes plural symbols (e.g., 14 or 12 symbols) in the time domain. For each numerology (e.g. subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g. radio resource control (RRC) signaling), where N^{size,u}_{grid,x} is the number of resource blocks in the resource grid and the subscript x is DL for downlink and UL for uplink. N^{RB}_{SC} is the number of subcarriers per resource blocks. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g. RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, a resource block is defined by 12 consecutive subcarriers in the frequency domain.

In the 3GPP NR system, resource blocks are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n P_{RB} in the bandwidth part i and the common resource block n_{CRB} is as follows: n P_{RB}=n_{CRB}+N^{size}_{BWP,i}, where N^{size}_{BWP,i} is the common resource block where bandwidth part starts relative to CRB 0. The BWP includes a plurality of consecutive resource blocks. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

NR frequency bands are defined as 2 types of frequency range, FR1 and FR2. FR2 is may be also called millimeter wave (mmW). The frequency ranges in which NR can operate are identified as described in Table 3.

TABLE 3

| Frequency | | |
|---|---|---|
| Range | Corresponding frequency | |
| designation | range | Subcarrier Spacing |
| FR1 | 410 MHz-7125 MHz | 15, 30, 60 kHz |
| FR2 | 24250 MHz-52600 MHz | 60, 120, 240 kHz |

FIG. 6 illustrates a data flow example in the 3GPP NR system.

In FIG. 6, “RB” denotes a radio bearer, and “H” denotes a header. Radio bearers are categorized into two groups: data radio bearers (DRB) for user plane data and signaling radio bearers (SRB) for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to physical uplink shared channel (PUSCH) and physical random access channel (PRACH), respectively, and the downlink transport channels DL-SCH, BCH and PCH are mapped to physical downlink shared channel (PDSCH), physical broad cast channel (PBCH) and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

For UCI transmission/reception, the following PUCCH formats may be used.

TABLE 4

| | Length in | Number of |
|---|---|---|
| PUCCH format | OFDM symbols | UCI bits |
| 0 | 1-2 | =<2 |
| 1 | 4-14 | =<2 |
| 2 | 1-2 | >2 |
| 3 | 4-14 | >2 |
| 4 | 4-14 | >2 |

PUCCH format 0 is a short PUCCH of 1 or 2 symbols with small UCI payloads of up to two bits. PUCCH format 1 is a long PUCCH of 4 to 14 symbols with small UCI payloads of up to 2 bits. PUCCH format 2 is a short PUCCH of 1 or 2 symbols with large UCI payloads of more than two bits with no UE multiplexing capability in the same PRBs. PUCCH format 3 is a long PUCCH of 4 to 14 symbols with large UCI payloads with no UE multiplexing capability in the same PRBs. PUCCH format 4 is a long PUCCH of 4 to 14 symbols with moderate UCI payloads with multiplexing capacity of up to 4 UEs in the same PRBs. For each PUCCH format, resource location is configured by RRC signalling. For example, IE PUCCH-Config is used to configure UE specific PUCCH parameters (per BWP).

In order to transmit data unit(s) of the present disclosure on UL-SCH, a UE shall have uplink resources available to the UE. In order to receive data unit(s) of the present disclosure on DL-SCH, a UE shall have downlink resources available to the UE. The resource allocation includes time domain resource allocation and frequency domain resource allocation. In the present disclosure, uplink resource allocation is also referred to as uplink grant, and downlink resource allocation is also referred to as downlink assignment. An uplink grant is either received by the UE dynamically on PDCCH, in a Random Access Response, or configured to the UE semi-persistently by RRC. Downlink assignment is either received by the UE dynamically on the PDCCH, or configured to the UE semi-persistently by RRC signaling from the BS.

In UL, the BS can dynamically allocate resources to UEs via the Cell Radio Network Temporary Identifier (C-RNTI) on PDCCH(s). A UE always monitors the PDCCH(s) in order to find possible grants for uplink transmission when its downlink reception is enabled (activity governed by discontinuous reception (DRX) when configured). In addition, with Configured Grants, the BS can allocate uplink resources for the initial HARQ transmissions to UEs. Two types of configured uplink grants are defined: Type 1 and Type 2. With Type 1, RRC directly provides the configured uplink grant (including the periodicity). With Type 2, RRC defines the periodicity of the configured uplink grant while PDCCH addressed to Configured Scheduling RNTI (CS-RNTI) can either signal and activate the configured uplink grant, or deactivate it; i.e. a PDCCH addressed to CS-RNTI indicates that the uplink grant can be implicitly reused according to the periodicity defined by RRC, until deactivated.

In DL, the BS can dynamically allocate resources to UEs via the C-RNTI on PDCCH(s). A UE always monitors the PDCCH(s) in order to find possible assignments when its downlink reception is enabled (activity governed by DRX when configured). In addition, with Semi-Persistent Scheduling (SPS), the BS can allocate downlink resources for the initial HARQ transmissions to UEs: RRC defines the periodicity of the configured downlink assignments while PDCCH addressed to CS-RNTI can either signal and activate the configured downlink assignment, or deactivate it. In other words, a PDCCH addressed to CS-RNTI indicates that the downlink assignment can be implicitly reused according to the periodicity defined by RRC, until deactivated.

* Resource Allocation by PDCCH (i.e. Resource Allocation by DCI)

PDCCH can be used to schedule DL transmissions on PDSCH and UL transmissions on PUSCH, where the downlink control information (DCI) on PDCCH includes: downlink assignments containing at least modulation and coding format (e.g., modulation and coding scheme (MCS) index I_{MCS}), resource allocation, and hybrid-ARQ information related to DL-SCH; or uplink scheduling grants containing at least modulation and coding format, resource allocation, and hybrid-ARQ information related to UL-SCH. The size and usage of the DCI carried by one PDCCH are varied depending on DCI formats. For example, in the 3GPP NR system, DCI format 0_0 or DCI format 0_1 is used for scheduling of PUSCH in one cell, and DCI format 1_0 or DCI format 1_1 is used for scheduling of PDSCH in one cell.

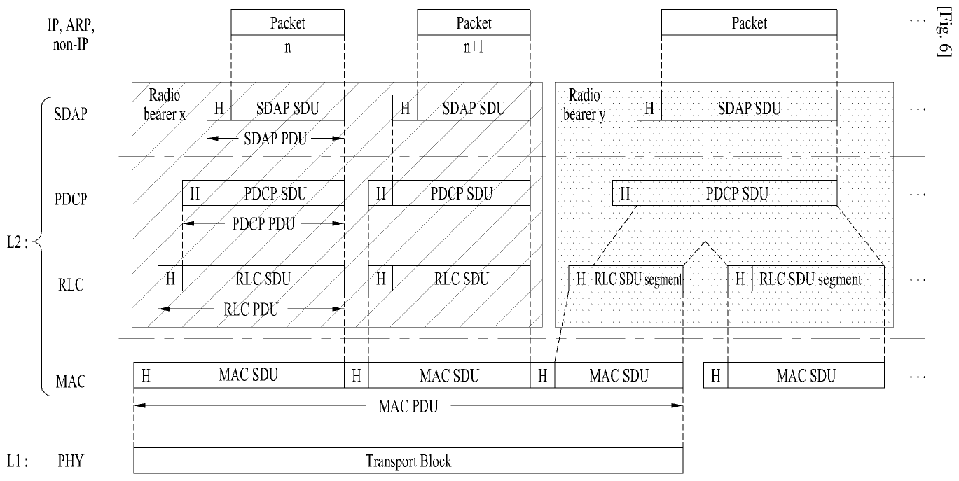

FIG. 7 illustrates an example of PDSCH time domain resource allocation by PDCCH, and an example of PUSCH time resource allocation by PDCCH.

Downlink control information (DCI) carried by a PDCCH for scheduling PDSCH or PUSCH includes a value m for a row index m+1 to an allocation table for PDSCH or PUSCH. Either a predefined default PDSCH time domain allocation A, B or C is applied as the allocation table for PDSCH, or RRC configured pdsch-TimeDomainAllocationList is applied as the allocation table for PDSCH. Either a predefined default PUSCH time domain allocation A is applied as the allocation table for PUSCH, or the RRC configured pusch-TimeDomainAllocationList is applied as the allocation table for PUSCH. Which PDSCH time domain resource allocation configuration to apply and which PUSCH time domain resource allocation table to apply are determined according to a fixed/predefined rule (e.g. Table 5.1.2.1.1-1 in 3GPP TS 38.214 v15.3.0, Table 6.1.2.1.1-1 in 3GPP TS 38.214 v15.3.0).

Each indexed row in PDSCH time domain allocation configurations defines the slot offset K₀, the start and length indicator SLIV, or directly the start symbol S and the allocation length L, and the PDSCH mapping type to be assumed in the PDSCH reception. Each indexed row in PUSCH time domain allocation configurations defines the slot offset K₂, the start and length indicator SLIV, or directly the start symbol S and the allocation length L, and the PUSCH mapping type to be assumed in the PUSCH reception. K₀ for PDSCH, or K₂ for PUSCH is the timing difference between a slot with a PDCCH and a slot with PDSCH or PUSCH corresponding to the PDCCH. SLIV is a joint indication of starting symbol S relative to the start of the slot with PDSCH or PUSCH, and the number L of consecutive symbols counting from the symbol S. For PDSCH/PUSCH mapping type, there are two mapping types: one is Mapping Type A where demodulation reference signal (DMRS) is positioned in 3^{rd} or 4^{th} symbol of a slot depending on the RRC signaling, and other one is Mapping Type B where DMRS is positioned in the first allocated symbol.

The scheduling DCI includes the Frequency domain resource assignment field which provides assignment information on resource blocks used for PDSCH or PUSCH. For example, the Frequency domain resource assignment field may provide a UE with information on a cell for PDSCH or PUSCH transmission, information on a bandwidth part for PDSCH or PUSCH transmission, information on resource blocks for PDSCH or PUSCH transmission.

* Resource Allocation by RRC

As mentioned above, in uplink, there are two types of transmission without dynamic grant: configured grant Type 1 where an uplink grant is provided by RRC, and stored as configured grant; and configured grant Type 2 where an uplink grant is provided by PDCCH, and stored or cleared as configured uplink grant based on L1 signaling indicating configured uplink grant activation or deactivation. Type 1 and Type 2 are configured by RRC per serving cell and per BWP. Multiple configurations can be active simultaneously only on different serving cells. For Type 2, activation and deactivation are independent among the serving cells. For the same serving cell, the MAC entity is configured with either Type 1 or Type 2.

A UE is provided with at least the following parameters via RRC signaling from a BS when the configured grant type 1 is configured:
cs-RNTI which is CS-RNTI for retransmission;
periodicity which provides periodicity of the configured grant Type 1;
timeDomainOffset which represents offset of a resource with respect to SFN=0 in time domain;
timeDomainAllocation value m which provides a row index m+1 pointing to an allocation table, indicating a combination of a start symbol S and length L and PUSCH mapping type;
frequencyDomainAllocation which provides frequency domain resource allocation;

and
mcsAndTBS which provides I_{MCS} representing the modulation order, target code rate and transport block size. Upon configuration of a configured grant Type 1 for a serving cell by RRC, the UE stores the uplink grant provided by RRC as a configured uplink grant for the indicated serving cell, and initialise or re-initialise the configured uplink grant to start in the symbol according to timeDomainOffset and S (derived from SLIV), and to reoccur with periodicity. After an uplink grant is configured for a configured grant Type 1, the UE considers that the uplink grant recurs associated with each symbol for which: [(SFN*numberOfSlotsPerFrame (numberOfSymbolsPerSlot)+(slot number in the frame*numberOfSymbolsPerSlot)+symbol number in the slot]=(timeDomainOffset*numberOfSymbolsPerSlot+S+N*periodicity) modulo (1024*numberOfSlotsPerFrame*numberOfSymbolsPerSlot), for all N>=0.

A UE is provided with at least the following parameters via RRC signaling from a BS when the configured gran Type 2 is configured:
cs-RNTI which is CS-RNTI for activation, deactivation, and retransmission; and
periodicity which provides periodicity of the configured grant Type 2. The actual uplink grant is provided to the UE by the PDCCH (addressed to CS-RNTI). After an uplink grant is configured for a configured grant Type 2, the UE considers that the uplink grant recurs associated with each symbol for which: [(SFN*numberOfSlotsPerFrame*numberOfSymbolsPerSlot)+(slot number in the frame*numberOfSymbolsPerSlot)+symbol number in the slot]=[(SFN_{start time}*numberOfSlotsPerFrame*numberOfSymbolsPerSlot+slot_{start time}*numberOfSymbolsPerSlot+symbol_{start time})+N*periodicity] modulo(1024*numberOfSlotsPerFrame*numberOfSymbolsPerSlot), for all N>=0, where SFN_{start time}, slot_{start time}, and symbol_{start time}are the SFN, slot, and symbol, respectively, of the first transmission opportunity of PUSCH where the configured uplink grant was (re-)initialised. numberOfSlotsPerFrame and numberOfSymbolsPerSlot refer to the number of consecutive slots per frame and the number of consecutive OFDM symbols per slot, respectively (see Table 1 and Table 2).

For configured uplink grants, the HARQ Process ID associated with the first symbol of a UL transmission is derived from the following equation:

HARQ Process ID=[floor(CURRENT_symbol/periodicity)]modulo nrofHARQ-Processes

where CURRENT_symbol=(SFN numberOfSlotsPerFrame numberOfSymbolsPerSlot+slot number in the frame*numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in TS 38.211. CURRENT_symbol refers to the symbol index of the first transmission occasion of a repetition bundle that takes place. A HARQ process is configured for a configured uplink grant if the configured uplink grant is activated and the associated HARQ process ID is less than nrofHARQ-Processes.

For downlink, a UE may be configured with semi-persistent scheduling (SPS) per serving cell and per BWP by RRC signaling from a BS. Multiple configurations can be active simultaneously only on different serving cells. Activation and deactivation of the DL SPS are independent among the serving cells. For DL SPS, a DL assignment is provided to the UE by PDCCH, and stored or cleared based on L1 signaling indicating SPS activation or deactivation. A UE is provided with the following parameters via RRC signaling from a BS when SPS is configured:
cs-RNTI which is CS-RNTI for activation, deactivation, and retransmission;
nrofHARQ-Processes: which provides the number of configured HARQ processes for SPS;
periodicity which provides periodicity of configured downlink assignment for SPS. When SPS is released by upper layers, all the corresponding configurations shall be released.

After a downlink assignment is configured for SPS, the UE considers sequentially that the N^{th} downlink assignment occurs in the slot for which: (numberOfSlotsPerFrame*SFN+slot number in the frame)=[(numberOfSlotsPerFrame SFN_{start time}+slot_{start time})+N*periodicity*numberOfSlotsPerFrame/10]modulo(1024*numberOfSlotsPerFrame), where SFN_{start time} and slot_{start time} are the SFN and slot, respectively, of the first transmission of PDSCH where the configured downlink assignment was (re-)initialised.

For configured downlink assignments, the HARQ Process ID associated with the slot where the DL transmission starts is derived from the following equation:

HARQ Process ID=[floor(CURRENT_slot*10/(numberOfSlotsPerFrame*periodicity))]modulo nrofHARQ-Processes

where CURRENT_slot=[(SFN*numberOfSlotsPerFrame)+slot number in the frame] and numberOfSlotsPerFrame refers to the number of consecutive slots per frame as specified in TS 38.211.

A UE validates, for scheduling activation or scheduling release, a DL SPS assignment PDCCH or configured UL grant type 2 PDCCH if the cyclic redundancy check (CRC) of a corresponding DCI format is scrambled with CS-RNTI provided by the RRC parameter cs-RNTI and the new data indicator field for the enabled transport block is set to 0. Validation of the DCI format is achieved if all fields for the DCI format are set according to Table 5 or Table 6. Table 5 shows special fields for DL SPS and UL grant Type 2 scheduling activation PDCCH validation, and Table 6 shows special fields for DL SPS and UL grant Type 2 scheduling release PDCCH validation.

TABLE 5

| | DCI format 0_0/0_1 | DCI format 1_0 | DCI format 1_1 |
|---|---|---|---|
| HARQ process | set to all ‘0’s | set to all ‘0’s | set to all ‘0’s |
| number | | | |
| Redundancy | set to ‘00’ | set to ‘00’ | For the enabled |
| version | | | transport |
| | | | block: set to ‘00’ |

TABLE 6

| | DCI format 0_0 | DCI format 1_0 |
|---|---|---|
| HARQ process number | set to all ‘0’s | set to all ‘0’s |
| Redundancy version | set to ‘00’ | set to ‘00’ |
| Modulation and coding | set to all ‘1’s | set to all ‘1’s |
| scheme | | |
| Resource block | set to all ‘1’s | set to all ‘1’s |
| assignment | | |

Actual DL assignment and actual UL grant, and the corresponding modulation and coding scheme are provided by the resource assignment fields (e.g. time domain resource assignment field which provides Time domain resource assignment value m, frequency domain resource assignment field which provides the frequency resource block allocation, modulation and coding scheme field) in the DCI format carried by the DL SPS and UL grant Type 2 scheduling activation PDCCH. If validation is achieved, the UE considers the information in the DCI format as valid activation or valid release of DL SPS or configured UL grant Type 2.

The MAC entity includes a HARQ entity for each Serving Cell with configured uplink (including the case when it is configured with supplementary Uplink), which maintains a number of parallel HARQ processes. Each HARQ process supports one transport block (TB). Each HARQ process is associated with a HARQ process identifier. Each HARQ process is associated with a HARQ buffer.

For each uplink grant, the HARQ entity identifies the HARQ process associated with this grant. For each identified HARQ process, the HARQ entity obtains the MAC PDU to transmit from the Msg3 buffer if there is a MAC PDU in the Msg3 buffer and the uplink grant was received in a Random Access Response, and obtains the MAC PDU to transmit from the Multiplexing and assembly entity, if any, otherwise. If a MAC PDU to transmit has been obtained, the HARQ entity delivers the MAC PDU and the uplink grant and the HARQ information of the TB to the identified HARQ process, and instructs the identified HARQ process to trigger a new transmission.

The Logical Channel Prioritization (LCP) procedure is applied whenever a new transmission is performed. RRC controls the scheduling of uplink data by signalling for each logical channel per MAC entity:
priority where an increasing priority value indicates a lower priority level;
prioritisedBitRate which sets the Prioritized Bit Rate (PBR);
bucketSizeDuration which sets the Bucket Size Duration (BSD).

RRC additionally controls the LCP procedure by configuring mapping restrictions for each logical channel:
allowedSCS-List which sets the allowed Subcarrier Spacing(s) for transmission;
maxPUSCH-Duration which sets the maximum PUSCH duration allowed for transmission;
configuredGrantTypelAllowed which sets whether a configured grant Type 1 can be used for transmission;
allowedServingCells which sets the allowed cell(s) for transmission.

The UE variable Bj which is maintained for each logical channel j is used for the Logical channel prioritization procedure. The MAC entity initializes Bj of the logical channel to zero when the logical channel is established. For each logical channel j, the MAC entity shall:

1> increment Bj by the product PBR*T before every instance of the LCP procedure, where T is the time elapsed since Bj was last incremented;

1> if the value of Bj is greater than the bucket size (i.e. PBR*BSD):

2>> set Bj to the bucket size.

The MAC entity shall, when a new transmission is performed:

1> select the logical channels for each UL grant that satisfy all the following conditions:

2>> the set of allowed Subcarrier Spacing index values in allowedSCS-List, if configured, includes the Subcarrier Spacing index associated to the UL grant; and

2>> maxPUSCH-Duration, if configured, is larger than or equal to the PUSCH transmission duration associated to the UL grant; and

2>> configuredGrantType1Allowed, if configured, is set to TRUE in case the UL grant is a Configured Grant Type 1; and

2>> allowedServingCells, if configured, includes the Cell information associated to the UL grant. Does not apply to logical channels associated with a DRB configured with PDCP duplication for which PDCP duplication is deactivated.

The Subcarrier Spacing index, PUSCH transmission duration and Cell information are included in Uplink transmission information received from lower layers (e.g. PHY) for the corresponding scheduled uplink transmission.

The MAC entity shall, when a new transmission is performed:

1> allocate resources to the logical channels as follows:

2>> logical channels selected as described above for the UL grant with Bj>0 are allocated resources in a decreasing priority order. If the PBR of a logical channel is set to “infinity”, the MAC entity shall allocate resources for all the data that is available for transmission on the logical channel before meeting the PBR of the lower priority logical channel(s);

2>> decrement Bj by the total size of MAC SDUs served to logical channel j above;

2>> if any resources remain, all the logical channels selected as described above are served in a strict decreasing priority order (regardless of the value of Bj) until either the data for that logical channel or the UL grant is exhausted, whichever comes first. Logical channels configured with equal priority should be served equally.

Logical channels are prioritised in accordance with the predefined order, e.g., the following order (highest priority listed first):
C-RNTI MAC control element (CE) or data from UL-CCCH;
Configured Grant Confirmation MAC CE;
MAC CE for buffer status report (BSR), with exception of BSR included for padding;
Single Entry power headroom report (PHR) MAC CE or Multiple Entry PHR MAC

CE;
data from any Logical Channel, except data from UL-CCCH;
MAC CE for Recommended bit rate query;
MAC CE for BSR included for padding.

The MAC entity shall multiplex MAC CEs and MAC SDUs in a MAC PDU according to the logical channel prioritization and the MAC PDU structure.

A MAC PDU consists of one or more MAC subPDUs. Each MAC subPDU consists of one of the following: i) a MAC subheader only (including padding); ii) a MAC subheader and a MAC SDU; iii) a MAC subheader and a MAC CE; iv) a MAC subheader and padding. The MAC SDUs are of variable sizes.

The NR may support the BWP operation for a cell with a wide bandwidth larger than 20 MHz. In some scenarios, a Scell of a UE may be configured with one or multiple BWPs and only one of the configured BWP can be active for a given time. In the meantime, as more communication devices demand larger communication capacity, efficient use of a limited frequency band in a future wireless communication system becomes increasingly important. Even in a cellular communication system such as a 3GPP based system, a method of using, for traffic offloading, an unlicensed band such as a band of 2.4 GHz used by a legacy Wi-Fi system or an unlicensed band such as a band of 5 GHz, which is newly in the spotlight, is under consideration. It may be required that radio technologies on an unlicensed band support a serving cell configured with bandwidth larger than 20 MHz. However, in some scenarios, it is required that a UE in an unlicensed band perform listen before talk (LBT) to determine whether the channel is idle or not, before transmitting a data. For example, while a BWP may be configured with a bandwidth larger than 20 MHz, the LBT may be performed in units of 20 MHz for the coexistence with Wi-Fi terminals. Considering these scenarios, the following options may be considered for operations based on BWP in unlicensed bands.
Option 1a: Multiple BWPs configured, multiple BWPs activated, transmission of PDSCH(s)/PUSCH(s) on one or more BWPs.
Option 1b: Multiple BWPs configured, multiple BWPs activated, transmission of a PDSCH/PUSCH on a single BWP.
Option 2: Multiple BWPs can be configured, single BWP activated, UE receives/transmits a PDSCH/PUSCH on a single BWP if channel assessment (CCA) is successful at network/UE for the whole BWP.
Option 3: Multiple BWPs can be configured, single BWP activated, UE receives/transmits a PDSCH/PUSCH on parts or whole of single BWP where CCA is successful at network/UE.

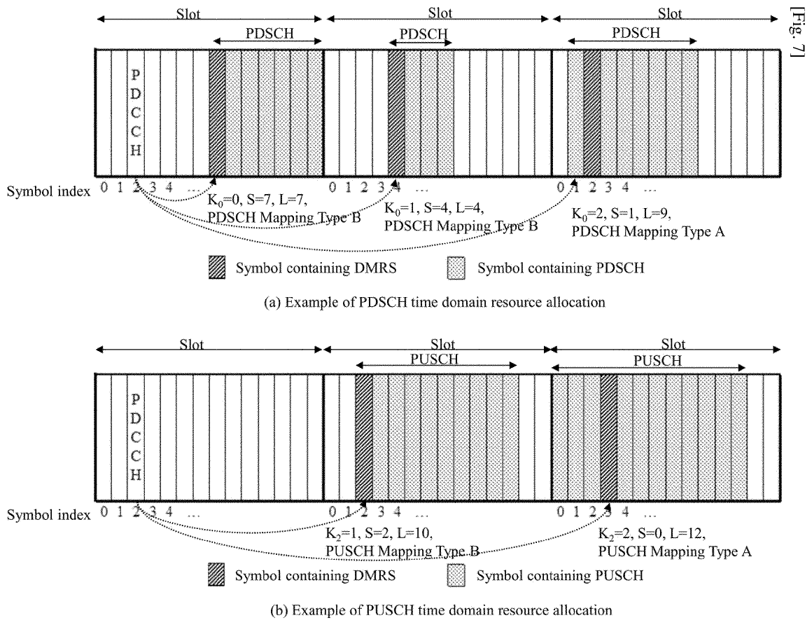

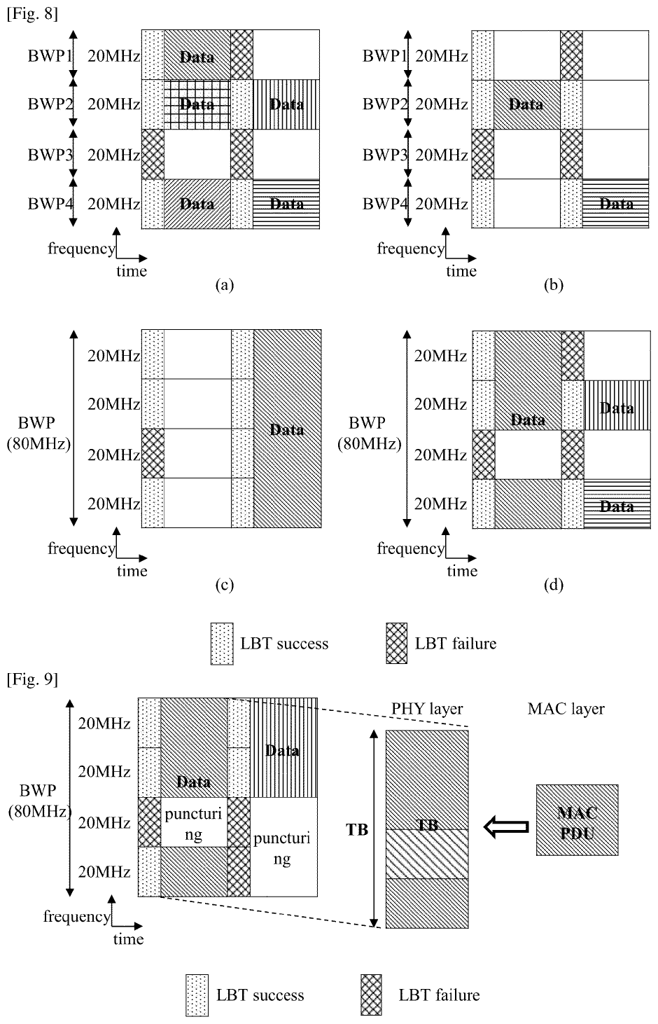

FIG. 8 illustrates examples of options related to bandwidth part (BWP) operation in unlicensed bands. In particular, FIG. 8(a) illustrates an example of the above-mentioned Option 1a, FIG. 8(b) illustrates an example of the above-mentioned Option 1b, FIG. 8(c) illustrates an example of the above-mentioned Option 3. In the examples of FIG. 8, it is assumed that LBT is performed in units of 20 MHz.

In some scenarios (e.g. related to Option 1a or 1b), multiple BWPs may be active for a carrier on unlicensed band. In some scenarios (e.g. related to Option 2 and 3), it may be restricted that only one BWP is active for a carrier on unlicensed bands. For convenience, the following descriptions focus on Option 2 and Option 3.

In the present disclosure, successful or succeeded LBT for a frequency resource may mean that a UE/network has determined, based on LBT for the frequency resource, that the frequency resource is available for transmission. In the present disclosure, failed LBT or LBT failure for a frequency resource may mean that a UE/network has determined, based on LBT for the frequency resource, that the frequency resource is available for transmission.

In the present disclosure, the terms “LBT region”, “LBT band”, “LBT subband”, and “subband” are used interchangeable.

In the present disclosure, the terms “LBT” and “CCA” are sometimes used interchangeable.

For convenience, implementations of the present disclosure are mainly described based on i) an UL grant covering a whole BWP or ii) an UL grant covering an LBT subband. The implementations of the present disclosure may be also applied for an UL grant not covering the whole BWP but involving multiple LBT subbands, or for an UL grant covering only part of an LBT subband. For example, the operations relating to an UL grant for a whole BWP may be also applicable to an UL grant involving 2, 3, . . . , or N−1 LBT subbands, where there are N LBT subbands on the BWP. For another example, the operations related to an UL grant for a single LBT subband on a BWP may be also applicable to an UL grant covering only part of an LBT subband.

For UL transmission, in Option 2, a UE may receive a UL grant for a frequency resource spanning multiple subbands, and then the UE transmits UL data only when CCA is successful for the frequency resource. For example, referring to FIG. 8(c), in Option 2, a UE may receive a UL grant for the whole BWP configured on a carrier/cell, and then the UE transmit data by using the allocated entire UL resource if CCA is successful for the whole BWP. In some scenarios where Option 2 is applied, the UE may lose the chance of data transmission when the channel occupancy rate of a specific subband(s) is high. However, Option 2 is advantageous in that Option 2 is very simple scheme to apply and particularly suitable for data transmission requiring a wide bandwidth. In Option 2, a MAC of a UE may generate a MAC PDU based on the UL resources for the whole BWP (e.g., 80 MHz in the example of FIG. 8(c)) when receiving the UL grant for the whole BWP, and delivers the MAC PDU to lower layer (e.g., PHY), irrespective of LBT results. The UE does not transmit the MAC PDU if an LBT failure occurs in at least one of subbands, and then the UE would eventually receive a HARQ NACK or UL grant for retransmission of the MAC PDU. Then, the UE may attempt to perform retransmission of the MAC PDU. For this reason, Option 2 is beneficial when the channel is mostly idle. If the network can guarantee the LBT success at the UE, it will be natural for the network to allocate the UL resources for the whole BWP to the UE. But, in Option 2, since it is difficult for the network to predict the LBT result at the time a UE transmits UL data, not the entire resources may be used due to the LBT failure for a specific sub-band.

For UL transmission, in Option 3, a UE may receive a UL grant for a frequency resource spanning multiple subbands, and then the UE transmits UL data on the part or whole of the frequency resource where CCA is successful. For example, referring to FIG. 8(d), in Option 3, a UE may receive one UL grant for the whole BWP or may receive multiple UL grants for multiple subbands. There are various transmission schemes.

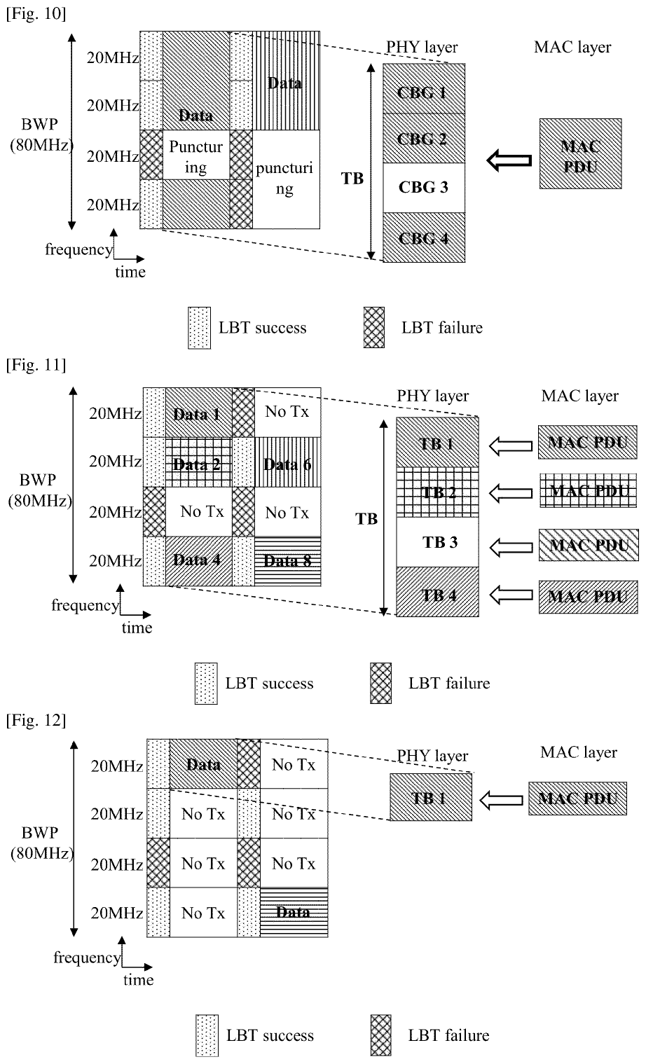

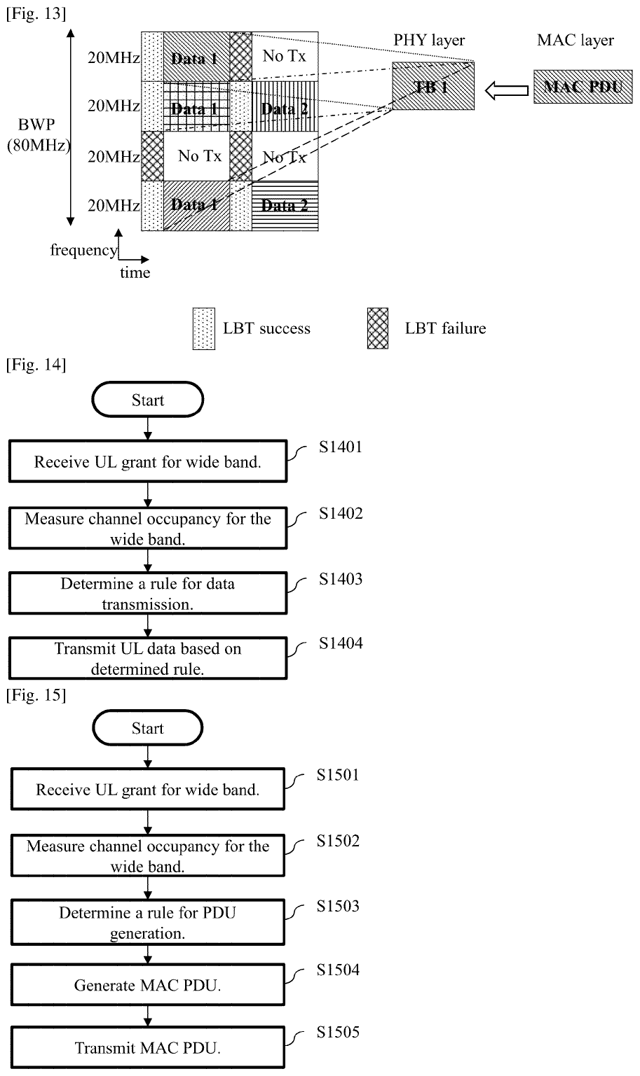

FIG. 9 to FIG. 13 illustrate examples of generating MAC PDU or TB according to some transmission schemes. In particular, FIG. 9 illustrates an example of puncturing physical resource(s) in units of (LBT) subband, FIG. 10 illustrates an example related to subband based or code block group (CBG) based HARQ-ACK, FIG. 11 illustrates an example of generating a MAC PDU based on a UL grant per subband, FIG. 12 illustrates an example of generating only one MAC PDU based on a subband, and FIG. 13 illustrates another example of generating only one MAC PDU based on subband.

In the example illustrated in FIG. 9, it is assumed that a UL grant for a whole BWP with a bandwidth 80 MHz is given to a UE, and there are 4 subbands on the BWP. Referring to FIG. 9, a MAC entity of a UE may generate a MAC PDU based on the UL grant for the whole BWP. The PHY layer of the UE transmits data on the BWP except the resources where the UE fails LBT among resources of the BWP. For example, the UE maps a TB corresponding to the MAC PDU to resources based on the UL grant, and transmits data of the TB on the BWP except subband(s) for which LBT is not successful by puncturing resources of the subband(s) among resources of the BWP. In some implementations of the present disclosure, the MAC entity of the UE may generate multiple PDUs of various versions for possible resources. For example, the MAC entity may generate a MAC PDU suitable for 80 MHz, a MAC PDU suitable for 60 MHz, a MAC PDU suitable for 40 MHz, and a MAC PDU suitable for 20 MHz. The PHY layer of the UE may transmit a MAC PDU suitable for subband(s) with successful CCA. In the example of FIG. 9, the UE may transmit the MAC PDU suitable for 60 MHz since CCA is successful at 3 subbands.

In the example illustrated in FIG. 10, it is assumed that a UL grant for a whole BWP with a bandwidth 80 MHz is given to a UE, and there are 4 subbands on the BWP. Referring to FIG. 10, a MAC entity of the UE may generate a MAC PDU based on the UL grant for the whole BWP. The PHY layer of the UE transmits code blocks of a TB corresponding to the MAC PDU, only on the subband(s) with successful LBT. For example, the UE maps code blocks of a TB corresponding to the MAC PDU to resources based on the UL grant, and transmits data of code blocks only mapped on subband(s) with successful LBT by puncturing resources of the subband with failed LBT. The network may provide the UE with HARQ-ACK information per code block group (CBG) or UL grant for retransmission per CBG. In the example of FIG. 10, the network may provide the UE with NACK for CBG3 or a UL grant for retransmission of CBG3.

In the example illustrated in FIG. 11, it is assumed that a UL grant per subband or a UL grant not larger than a subband is given to a UE, and there are 4 subbands on the BWP. Referring to FIG. 11, a MAC entity of the UE may generate one or more MAC PDUs based on a UL grant for each of the subbands. The PHY layer of the UE transmits respective data, only on the subband(s) with successful LBT. For example, the UE maps respective 4 TBs (TB1 to TB4) for 4 MAC PDUs to resources based on the UL grant, and transmits data of some TBs only on the subband(s) with successful LBT except a TB mapped on the subband with failed LBT.

In the examples illustrated in FIG. 12 and FIG. 13, it is assumed that a UL grant for a subband is given to a UE, and there are 4 subbands on the BWP. Referring to FIG. 12 and FIG. 13, a MAC entity of the UE may generate only one MAC PDU based on a UL grant for a subband. Referring to FIG. 12, the PHY layer of the UE transmits data on one of subbands with successful LBT. Alternatively, referring to FIG. 13, the PHY layer of the UE repeatedly transmits data on all the subbands with successful LBT.

Depending on the data transmission schemes illustrated in FIG. 9 to FIG. 13, a UE transmits data only using the UL resource(s) which LBT is successful at the UE. In Option 3, a UE may not use a bandwidth allocated by a UL grant, but may use a part of the bandwidth based on more than one LBT opportunities in the bandwidth. However, in Option 3, it might be required to define additional schemes, such as physical resource puncturing in units of subband (e.g. in the example illustrated in FIG. 9), code block group (CBG) or subband based ACK/NACK for the same HARQ process (e.g. in the example illustrated in FIG. 10), UL grant per subband or multiple UL grants with different HARQ processes for a given time (e.g. in the example illustrated in FIG. 11), only one TB generation for 20 MHz (e.g. in the examples illustrated in FIG. 12 and FIG. 13), and/or etc.

In some scenarios, the simplest way in Option 3 is that a UE always generates only one MAC PDU for 20 MHz regardless of the whole bandwidth size of BWP, and transmits the MAC PDU only on the resource of the selected one of the subbands in which LBT succeeds. However, since this means that the UE may give up the several resources for which LBT is successful, it may be considered transmitting one MAC PDU repeatedly on all the subbands for which LBT is successful, as shown in FIG. 13. In this case, the UE may use different redundancy versions (RVs) for UL transmissions on different subbands.

In the system aspect, the repetitions of data transmission make the channel occupancy increase. Even if the UE transmits data on only one of subbands where LBT is successful, it provides UEs with more opportunities for LBT in a frequency domain.

If LBTs for all the subbands are almost successfully performed in a UE since the channel is not busy, the newly defined schemes for Option 3 may cause the increase of the UE complexity or the degradation of the resource efficiency. Therefore, in some implementations, Option 3 may be preferably applied when the channel occupancy is high.

FIG. 14 illustrates an example of a flow diagram for data transmission in unlicensed bands according to some implementations of the present disclosure.

In some implementations of the present disclosure, a UE may select one of rules to transmit a MAC PDU/PUSCH based on channel occupancy measured at the UE when the UE receives a UL grant for a wide bandwidth larger than 20 MHz in an unlicensed band. The rules to transmit a MAC PDU/PUSCH for a wide bandwidth larger than 20 MHz may comprise the followings:
Rule 1-1: For an active BWP, a UE transmits a PUSCH on the BWP if CCA/LBT is successful at the UE for the whole BWP (e.g. as in the example of FIG. 8(c), Option 2). It is preferably used when the channel occupancy is low.
Rule 2-1: For an active BWP, a UE transmits a PUSCH on parts or whole of the BWP where CCA is successful at the UE (e.g. as in the example of FIG. 8(d), Option 3). It is preferably used when the channel occupancy is high.

Referring to FIG. 14, for example, a UE may receive a UL grant for a wide band (S1401), the wide band i) being wider than a predetermined value, ii) operating on an unlicensed band and iii) including multiple subbands. The UE measures channel occupancy for the wide band (S1402). The UE determines a transmission rule for transmitting UL data among a plurality of transmission rules, based on the measured channel occupancy (S1403). The UE transmits the UL data according to the determined rule (S1404). The plurality of rules comprises Rule 1-1 in which the UE transmits the UL data, only when clear channel assessment (CCA) is successful for the whole wide band, and Rule 2-1 in which the UE transmits the UL data, when CCA is successful for at least one subband among the multiple subbands. The UE may transmit the UL data on the wide band according to Rule 1-1, based on the measured channel occupancy being below a first threshold value. The UE may transmit the UL data on the one or more subband only, according to Rule 2-1, based on the measured channel occupancy being above the first threshold value. The UE may receive information regarding the first threshold value from a network. The UE may generate a MAC PDU including the UL data. The UE may generate the MAC PDU in units of the whole wide band based on the measured channel occupancy being below a second threshold value. The UE may generate the MAC PDU in units of subband based on the measured channel occupancy based on above the second threshold value. The UE may receive information regarding the second threshold value from the network. The UE may randomly select one of subbands for which CCA is successful, based on the measured channel occupancy being above the first threshold value, and transmit the UL data on the selected subband only.

Alternately or additionally, in some implementations of the present disclosure, a UE may select one of rules to generate a MAC PDU based on the measured channel occupancy when the UE receives a UL grant for a wide bandwidth larger than 20 MHz in an unlicensed band. The rules to generate a MAC PDU for a wider bandwidth larger than 20 MHz may comprise the followings:
Rule 1-2: For an active BWP, a UE generates a MAC PDU for the whole BWP based on the received UL grant (Option 2 and Option 3 (see FIG. 9/FIG. 10)). It is preferably used when the channel occupancy is low.
Rule 2-2: For an active BWP, a UE generates a MAC PDU for LBT units of subband based on the received UL grant (Option 3 (see FIG. 11/FIG. 12/FIG. 13). It is preferably used when the channel occupancy is high.

FIG. 15 illustrates another example of a flow diagram for data transmission in unlicensed bands according to some implementations of the present disclosure.

Referring to FIG. 15, for example, a UE may receive a UL grant for a wide band (S1501), the wide band i) being wider than a predetermined value, ii) operating on an unlicensed band and iii) including multiple subbands. The UE measures channel occupancy for the wide band (S1502). The UE determines whether to generate a MAC PDU in units of the whole wide band or in units of subband, based on the measured channel occupancy (S1503). The UE generates the MAC PDU in units of the whole wide band (according to Rule 1-1) or in units of subband (according to Rule 2-2) (S1504). The UE performs CCA per subband, and transmits the generated MAC PDU via at least one subband where the CCA is successful (S1505). The UE may generate the MAC PDU in units of the whole wide band based on the measured channel occupancy being below a first threshold value. The UE may generate the MAC PDU in units of subband based on the measured channel occupancy being above the first threshold value. The UE may receive information regarding the first threshold value from a network. The UE may determine whether to transmit the generated MAC PDU, based on (i) generating the MAC PDU in units of the whole wide band and (ii) the CCA being successful for only some of the multiple subbands. For example, the UE may transmit the generated MAC PDU, only when the CCA is successful for the whole wide band, based on the measured channel occupancy being below a second threshold value. The UE may transmit the generated MAC PDU, when the CCA is successful for at least one subband among the multiple subbands, based on the measured channel occupancy being below the second threshold value. The UE may receive information regarding the second threshold value from the network.

Alternately or additionally, in some implementations of the present disclosure, a UE may selects one of rules for subband selection based on the measured channel occupancy when the UE receives a UL grant for a wide bandwidth larger than 20 MHz in an unlicensed band. This alternative assumes that the network may allocate the UL grant to one or more UEs. A UE receiving the UL grant selects only one subband based on the selected/indicated rule. The rules for subband selection may comprise the followings.
Rule 1-3: For an active BWP, a UE may select the best one of subbands with successful LBT. The best subband may be a subband with the lowest energy level among subbands at which LBT succeeds. It is preferably used when the channel occupancy is low.
Rule 2-3: For an active BWP, a UE may randomly select one of subbands with successful LBT with equal probability. It is preferably used when the channel occupancy is high.

In particular, a UE may select a rule based on an indication transmitted by the network (NW), or based on the channel occupancy measured by the UE. For example, the following methods may be considered.
Method 1: A network may inform UE(s) of a rule for MAC PDU generation/data transmission. The network may transmit information regarding the rules via system information. For example, the network may provide a UE with information regarding whether the UE use Option 2 or Option 3. Alternatively, the rules for MAC PDU generation/data transmission may be defined in the standards specification of the wireless communication. The network may select a rule based on the measured channel occupancy, channel quality, UE power status, etc. The information regarding rule(s) for MAC PDU generation and/or data transmission may be transmitted through an RRC message (e.g. system information), or physical control signaling (e.g. PDCCH on common search space and/or (e.g. UL grant) PDCCH on UE-specific search space). The information regarding rule(s) for MAC PDU generation and/or data transmission may inform a UE whether the UE receiving a UL grant for wide bandwidth generates/transmits a MAC PDU/PUSCH based on a subband for LBT or based on the whole BWP.

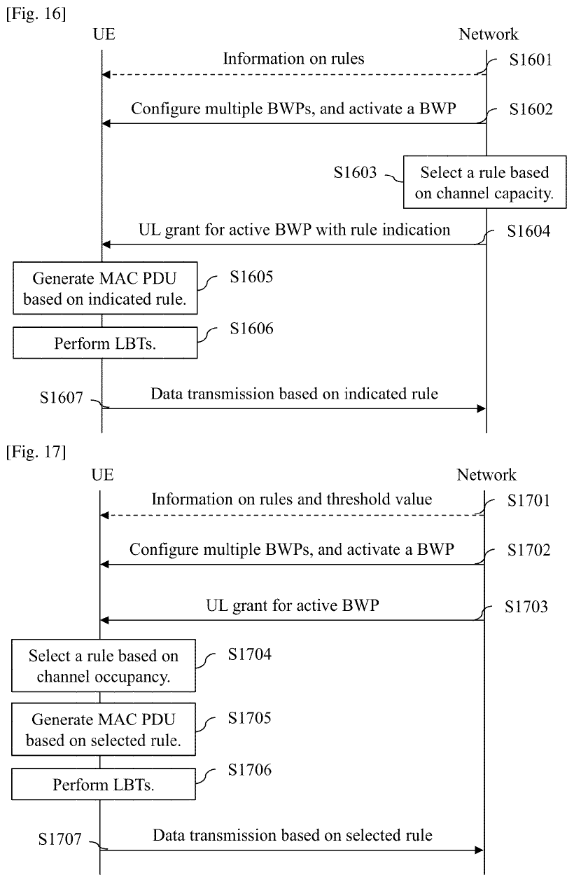

FIG. 16 illustrates an example of UE/network behavior according to some implementations of the present disclosure. In particular, FIG. 16 illustrates an example of UE/network behavior based on Method 1.

Referring to FIG. 16, a UE may receive an RRC message including information regarding rules for MAC PDU generation/data transmission in an unlicensed band with a wide bandwidth larger than a band size for LBT (e.g. 20 MHz) (S1601). The UE may be configured with one or multiple BWPs on the unlicensed band, and a BWP lager than the band size for LBT may be activated on the unlicensed band (S1602). The UE may receive a UL grant for the active BWP with information indicating a rule for MAC PDU generation/data transmission (S1604). The UE may generate a MAC PDU based on the indicated rule (S1605). The UE performs LBT in units of subband on the unlicensed band (S1606). The UE transmits data of the MAC PDU on the UL resource/subband(s) where LBT is successfully performed by the UE (S1607).

Referring to FIG. 16, the network may transmit a RRC message including information regarding the rules for MAC PDU generation/data transmission in the unlicensed band with the wide bandwidth (S1601). The network may select a rule based on the channel occupancy on the unlicensed band (S1603). The network transmits a UL grant for the active BWP with information indicating the selected rule (S1604). The network may receive a MAC PDU/data on the PUSCH from a UE based on the selected rule (S1607).
Method 2. A UE may select a rule for MAC PDU generation/data transmission based on the channel occupancy among rules for MAC PDU generation/data transmission. The rules for MAC PDU generation/data transmission may be provided to a UE by a network, or be defined in the standards specification of the wireless communication. In the present disclosure, the channel occupancy may be a value of the most recently measured channel occupancy at a UE before receiving an UL grant for a wide bandwidth; or a value of the most recently received channel occupancy from a BS before/when a UE receives an UL grant for a wide bandwidth.

In Method 2, for example, a UE may get information regarding rules for MAC PDU generation/data transmission in an unlicensed band with a wide bandwidth. A BWP larger the band size for LBT (e.g. 20 MHz) may be configured and activated on the unlicensed band with the wide bandwidth. The UE may receive a UL grant for a wide bandwidth. The UE may generate a MAC PDU based on a rule selected by the UE, and/or transmit data of the MAC PDU based on the selected rule. The UE may select a rule for MAC PDU generation/data transmission among the multiple rules for MAC PDU generation/data transmission.

FIG. 17 illustrates another example of UE/network behavior according to some implementations of the present disclosure. In particular, FIG. 17 illustrates an example of UE/network behavior based on Method 2.

Referring to FIG. 17, a UE may receive an RRC message including information regarding rules for MAC PDU generation/data transmission in an unlicensed band with a wide bandwidth larger than a band size for LBT (e.g. 20 MHz) (S1701). The RRC message may include a threshold value for channel occupancy. In the example of FIG. 17, the rules for MAC PDU generation/data transmission may comprise rule 1 and rule 2. The rule 1 may comprise at least Rule 1-1, Rule 1-2, and/or Rule 1-3, and the rule 2 may comprise at least Rule 2-1, Rule 2-2, and/or Rule 1-3.

The UE may be configured with one or multiple BWPs on the unlicensed band, and a BWP lager than the band size for LBT may be activated on the unlicensed band (S1702). The UE may receive a UL grant for the active BWP (S1703). The UE checks whether the value of the most recently measured channel occupancy is below than the threshold value. The UE selects a rule based on the measured channel occupancy (S1704). For example, if the channel occupancy is less than the threshold, the UE selects the rule 1, and else if the channel occupancy is above the threshold, the UE selects the rule 2. The UE generates a MAC PDU (or MAC PDUs) based on the selected rule (S1705). The UE performs LBT in units of subband on the unlicensed band (S1706). The UE transmits data of the MAC PDU(s) on the UL resource/subband(s) where LBT is successfully performed by the UE (S1707).

Referring to FIG. 17, the network may transmit a RRC message including information regarding the rules for MAC PDU generation/data transmission in the unlicensed band with the wide bandwidth (S1701). The RRC message may include the threshold value for the channel occupancy. The network may configure a UE with multiple BWPs, and activate a BWP for the UE which is larger than a band size for LBT (e.g. 20 MHz) (S1702). The network may transmit a UL grant for the active BWP (S1703). The network receives a MAC PDU/data on a PUSCH based on the UL grant (S1707). The network may perform blind decoding on all possible combinations of MAC PDUs that can be generated by the UE.

In some implementations of the present disclosure, a MAC PDU is transmitted/received on a physical channel (e.g. PUSCH) based on resource allocation (e.g. UL grant). For example, a UE may generate a MAC PDU for a UL transmission according to some implementations of the present disclosure, and transmit the MAC PDU through a PUSCH based on a UL grant available to the UE. A network node (e.g. BS) may receive the MAC PDU through the PUSCH.

The processor(s) 102 may be configured to perform some implementations of the present disclosure. In particular, the processor(s) 102 may be configured to perform the UE behaviour according to some implementations of the present disclosure. The processor(s) 102 may be configured with a MAC entity performing some implementations of the present disclosure. The processor(s) 102 may be configured to obtain a UL grant based on some implementations of the present disclosure. The UE processor may be configured to perform (or control the transceiver(s) 106 to perform) the MAC PDU based on the UL grant.

The processor(s) 202 may be configured to perform some implementations of the present disclosure. In particular, the processor(s) 202 may be configured to perform the NW behaviour according to some implementations of the present disclosure. The processor(s) 202 may be configured with a MAC entity performing some implementations of the present disclosure.

For UL, the processor(s) 102 may generate a MAC PDU according to some implementations of the present disclosure. The processor(s) 102 of the present disclosure may transmit (or control the transceiver(s) 106 to transmit) a MAC PDU according to some implementations of the present disclosure. The processor(s) 202 of the present disclosure may receive (or control the transceiver(s) 206 to receive) the MAC PDU based on the UL grant available to the UE.

The MAC PDU according to some implementations of the present disclosure is subject to the physical layer processing at a transmitting side before transmission via radio interface, and the radio signals carrying the MAC PDU are subject to the physical layer processing at a receiving side. For example, a MAC PDU according to some implementations of the present disclosure may be subject to the physical layer processing.

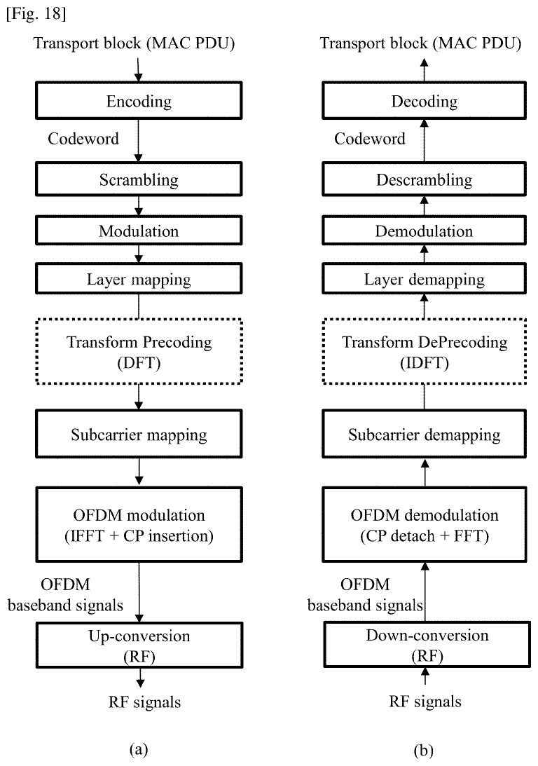

FIG. 18 illustrates an example of physical layer processing for some implementations of the present disclosure.

FIG. 18(a) illustrates an example of physical layer processing at a transmitting side.

The following tables show the mapping of the transport channels (TrCHs) and control information to its corresponding physical channels. In particular, Table 7 specifies the mapping of the uplink transport channels to their corresponding physical channels, Table 8 specifies the mapping of the uplink control channel information to its corresponding physical channel, Table 9 specifies the mapping of the downlink transport channels to their corresponding physical channels, and Table 10 specifies the mapping of the downlink control channel information to its corresponding physical channel.

TABLE 7

| TrCH | Physical Channel |
|---|---|
| UL-SCH | PUSCH |
| RACH | PRACH |

TABLE 8

| Control information | Physical Channel |
|---|---|
| UCI | PUCCH, PUSCH |

TABLE 9

| TrCH | Physical Channel |
|---|---|
| DL-SCH | PDSCH |
| BCH | PBCH |
| PCH | PDSCH |

TABLE 10

| Control information | Physical Channel |
|---|---|
| DCI | PDCCH |

* Encoding

Data and control streams from/to MAC layer are encoded to offer transport and control services over the radio transmission link in the PHY layer. For example, a transport block from MAC layer is encoded into a codeword at a transmitting side. Channel coding scheme is a combination of error detection, error correcting, rate matching, interleaving and transport channel or control information mapping onto/splitting from physical channels.

In the 3GPP NR system, following channel coding schemes are used for the different types of TrCH and the different control information types.

TABLE 11

| TrCH | Coding scheme |
|---|---|
| UL-SCH | LDPC |
| DL-SCH | |
| PCH | |
| BCH | Polar code |

TABLE 12

| Control Information | Coding scheme |
|---|---|
| DCI | Polar code |
| UCI | Block code |
| | Polar code |

For transmission of a DL transport block (i.e. a DL MAC PDU) or a UL transport block (i.e. a UL MAC PDU), a transport block CRC sequence is attached to provide error detection for a receiving side. In the 3GPP NR system, the communication device uses low density parity check (LDPC) codes in encoding/decoding UL-SCH and DL-SCH. The 3GPP NR system supports two LDPC base graphs (i.e. two LDPC base matrixes): LDPC base graph 1 optimized for small transport blocks and LDPC base graph 2 for larger transport blocks. Either LDPC base graph 1 or 2 is selected based on the size of the transport block and coding rate R. The coding rate R is indicated by the modulation coding scheme (MCS) index I_{MCS}. The MCS index is dynamically provided to a UE by PDCCH scheduling PUSCH or PDSCH, provided to a UE by PDCCH activating or (re-)initializing the UL configured grant 2 or DL SPS, or provided to a UE by RRC signaling related to the UL configured grant Type 1. If the CRC attached transport block is larger than the maximum code block size for the selected LDPC base graph, the CRC attached transport block may be segmented into code blocks, and an additional CRC sequence is attached to each code block. The maximum code block sizes for the LDPC base graph 1 and the LDPC base graph 2 are 8448 bits and 3480 bits, respectively. If the CRC attached transport block is not larger than the maximum code block size for the selected LDPC base graph, the CRC attached transport block is encoded with the selected LDPC base graph. Each code block of the transport block is encoded with the selected LDPC base graph. The LDPC coded blocks are then individually rat matched. Code block concatenation is performed to create a codeword for transmission on PDSCH or PUSCH. For PDSCH, up to 2 codewords (i.e. up to 2 transport blocks) can be transmitted simultaneously on the PDSCH. PUSCH can be used for transmission of UL-SCH data and layer 1/2 control information. Although not shown in FIG. 18, the layer 1/2 control information may be multiplexed with the codeword for UL-SCH data.

* Scrambling and Modulation

The bits of the codeword are scrambled and modulated to generate a block of complex-valued modulation symbols.

* Layer Mapping

The complex-valued modulation symbols of the codeword are mapped to one or more multiple input multiple output (MIMO) layers. A codeword can be mapped to up to 4 layers. A PDSCH can carry two codewords, and thus a PDSCH can support up to 8-layer transmission. A PUSCH supports a single codeword, and thus a PUSCH can support up to 4-layer transmission.

* Transform Precoding

The DL transmission waveform is conventional OFDM using a cyclic prefix (CP). For DL, transform precoding (in other words, discrete Fourier transform (DFT)) is not applied.

The UL transmission waveform is conventional OFDM using a CP with a transform precoding function performing DFT spreading that can be disabled or enabled. In the 3GPP NR system, for UL, the transform precoding can be optionally applied if enabled. The transform precoding is to spread UL data in a special way to reduce peak-to-average power ratio (PAPR) of the waveform. The transform precoding is a form of DFT. In other words, the 3GPP NR system supports two options for UL waveform: one is CP-OFDM (same as DL waveform) and the other one is DFT-s-OFDM.

Whether a UE has to use CP-OFDM or DFT-s-OFDM is configured by a BS via RRC parameters.

* Subcarrier Mapping

The layers are mapped to antenna ports. In DL, for the layers to antenna ports mapping, a transparent manner (non-codebook based) mapping is supported and how beamforming or MIMO precoding is performed is transparent to the UE. In UL, for the layers to antenna ports mapping, both the non-codebook based mapping and a codebook based mapping are supported.

For each antenna port (i.e. layer) used for transmission of the physical channel (e.g. PDSCH, PUSCH), the complex-valued modulation symbols are mapped to subcarriers in resource blocks allocated to the physical channel.

* OFDM Modulation

The communication device at the transmitting side generates a time-continuous OFDM baseband signal on antenna port p and subcarrier spacing configuration u for OFDM symbol l in a TTI for a physical channel by adding a cyclic prefix (CP) and performing IFFT. For example, for each OFDM symbol, the communication device at the transmitting side may perform inverse fast Fourier transform (IFFT) on the complex-valued modulation symbols mapped to resource blocks in the corresponding OFDM symbol and add a CP to the IFFT-ed signal to generate the OFDM baseband signal.

* Up-Conversion

The communication device at the transmitting side up-convers the OFDM baseband signal for antenna port p, subcarrier spacing configuration u and OFDM symbol l to a carrier frequency f₀ of a cell to which the physical channel is assigned.

The processors 102 and 202 in FIG. 1B may be configured to perform encoding, scrambling, modulation, layer mapping, transform precoding (for UL), subcarrier mapping, and OFDM modulation. The processors 102 and 202 may control the transceivers 106 and 206 connected to the processors 102 and 202 to up-convert the OFDM baseband signal onto the carrier frequency to generate radio frequency (RF) signals. The radio frequency signals are transmitted through antennas 108 and 208 to an external device.

FIG. 18(b) illustrates an example of physical layer processing at a receiving side.

The physical layer processing at the receiving side is basically the inverse processing of the physical layer processing at the transmitting side.

* Frequency Down-Conversion

The communication device at a receiving side receives RF signals at a carrier frequency through antennas. The transceivers 106 and 206 receiving the RF signals at the carrier frequency down-converts the carrier frequency of the RF signals into the baseband in order to obtain OFDM baseband signals.

* OFDM Demodulation

The communication device at the receiving side obtains complex-valued modulation symbols via CP detachment and FFT. For example, for each OFDM symbol, the communication device at the receiving side removes a CP from the OFDM baseband signals and performs FFT on the CP-removed OFDM baseband signals to obtain complex-valued modulation symbols for antenna port p, subcarrier spacing u and OFDM symbol l.

* Subcarrier Demapping

The subcarrier demapping is performed on the complex-valued modulation symbols to obtain complex-valued modulation symbols of a corresponding physical channel. For example, the processor(s) 102 may obtain complex-valued modulation symbols mapped to subcarriers belong to PDSCH from among complex-valued modulation symbols received in a bandwidth part. For another example, the processor(s) 202 may obtain complex-valued modulation symbols mapped to subcarriers belong to PUSCH from among complex-valued modulation symbols received in a bandwidth part.

* Transform De-Precoding

Transform de-precoding (e.g. IDFT) is performed on the complex-valued modulation symbols of the uplink physical channel if the transform precoding has been enabled for the uplink physical channel. For the downlink physical channel and for the uplink physical channel for which the transform precoding has been disabled, the transform de-precoding is not performed.

* Layer Demapping.

The complex-valued modulation symbols are de-mapped into one or two codewords.

* Demodulation and Descrambling

The complex-valued modulation symbols of a codeword are demodulated and descrambled into bits of the codeword.

* Decoding

The codeword is decoded into a transport block. For UL-SCH and DL-SCH, either LDPC base graph 1 or 2 is selected based on the size of the transport block and coding rate R. The codeword may include one or multiple coded blocks. Each coded block is decoded with the selected LDPC base graph into a CRC-attached code block or CRC-attached transport block. If code block segmentation was performed on a CRC-attached transport block at the transmitting side, a CRC sequence is removed from each of CRC-attached code blocks, whereby code blocks are obtained. The code blocks are concatenated into a CRC-attached transport block. The transport block CRC sequence is removed from the CRC-attached transport block, whereby the transport block is obtained. The transport block is delivered to the MAC layer.

In the above described physical layer processing at the transmitting and receiving sides, the time and frequency domain resources (e.g. OFDM symbol, subcarriers, carrier frequency) related to subcarrier mapping, OFDM modulation and frequency up/down conversion can be determined based on the resource allocation (e.g., UL grant, DL assignment).

For uplink data transmission, the processor(s) 102 of the present disclosure may apply (or control the transceiver(s) 106 to apply) the above described physical layer processing of the transmitting side to UL data/signal (e.g. MAC PDU) of the present disclosure to transmit the UL data/signal wirelessly. For uplink data reception, the processor(s) 102 of the present disclosure may apply (or control the transceiver(s) 106 to apply) the above described physical layer processing of the receiving side to received radio signals to obtain the UL data/signal of the present disclosure.

For downlink data transmission, the processor(s) 202 of the present disclosure may apply (or control the transceiver(s) 206 to apply) the above described physical layer processing of the transmitting side to DL data/signal (e.g. MAC PDU) of the present disclosure to transmit the DL data/signal wirelessly. For downlink data reception, the processor(s) 202 of the present disclosure may apply (or control the transceiver(s) 206 to apply) the above described physical layer processing of the receiving side to received radio signals to obtain DL data/signal of the present disclosure.

In some implementations of the present disclosure, a UE uses the appropriate rule for MAC PDU generation and/or data transmission on unlicensed band based on the channel occupancy, thereby reducing the UE complexity and improving the resource efficiency in unlicensed band.

As described above, the detailed description of the preferred implementations of the present disclosure has been given to enable those skilled in the art to implement and practice the disclosure. Although the disclosure has been described with reference to exemplary implementations, those skilled in the art will appreciate that various modifications and variations can be made in the present disclosure without departing from the spirit or scope of the disclosure described in the appended claims. Accordingly, the disclosure should not be limited to the specific implementations described herein, but should be accorded the broadest scope consistent with the principles and novel features disclosed herein.

### INDUSTRIAL APPLICABILITY

The implementations of the present disclosure are applicable to a network node (e.g., BS), a UE, or other devices in a wireless communication system.

1. A method for transmitting a data unit by a user equipment (UE) in a wireless communication system, the method comprising:
receiving a uplink (UL) grant for a wide band, the wide band i) being wider than a predetermined value, ii) operating on an unlicensed band and iii) including multiple subbands;
measuring channel occupancy for the wide band;
determining whether to generate a medium access control (MAC) protocol data unit (PDU) in units of the whole wide band or in units of subband, based on the measured channel occupancy;
generating the MAC PDU in units of the whole wide band or in units of subband;
performing clear channel assessment (CCA) per subband; and
transmitting the generated MAC PDU via at least one subband where the CCA is successful.

2. The method according to claim 1,
wherein the UE generates the MAC PDU in units of the whole wide band based on the measured channel occupancy being below a first threshold value, and
wherein the UE generates the MAC PDU in units of subband based on the measured channel occupancy being above the threshold value.

3. The method according to claim 2, further comprising:
receiving information regarding the first threshold value.

4. The method according to claim 1, further comprising:
determining whether to transmit the generated MAC PDU, based on (i) generating the MAC PDU in units of the whole wide band and (ii) the CCA being successful for only some of the multiple subbands,
wherein the UE transmits the generated MAC PDU, only when the CCA is successful for the whole wide band, based on the measured channel occupancy being below a second threshold value, and
wherein the UE transmits the generated MAC PDU, when the CCA is successful for at least one subband among the multiple subbands, based on the measured channel occupancy being below the second threshold value.

5. The method according to claim 4, further comprising:
receiving information regarding the second threshold value.

6. A user equipment (UE) of transmitting a data unit in a wireless communication system, the UE comprising:
at least one transceiver;
at least one processor; and
at least one computer memory that is operably connectable to the at least one processor and that stores instructions that, when executed, cause the at least one processor to perform operations comprising:
receiving a uplink (UL) grant for a wide band, the wide band i) being wider than a predetermined value, ii) operating on an unlicensed band and iii) including multiple subbands;
measuring channel occupancy for the wide band;
determining whether to generate a medium access control (MAC) protocol data unit (PDU) in units of the whole wide band or in units of subband, based on the measured channel occupancy;
generating the MAC PDU in units of the whole wide band or in units of subband;
performing clear channel assessment (CCA) per subband; and
transmitting the generated MAC PDU via at least one subband where the CCA is successful.

7. An apparatus, the apparatus comprising:
at least one processor; and
at least one computer memory that is operably connectable to the at least one processor and that stores instructions that, when executed, cause the at least one processor to perform operations comprising:
receiving a uplink (UL) grant for a wide band, the wide band i) being wider than a predetermined value, ii) operating on an unlicensed band and iii) including multiple subbands;
measuring channel occupancy for the wide band;
determining whether to generate a medium access control (MAC) protocol data unit (PDU) in units of the whole wide band or in units of subband, based on the measured channel occupancy;
generating the MAC PDU in units of the whole wide band or in units of subband;
performing clear channel assessment (CCA) per subband; and
transmitting the generated MAC PDU via at least one subband where the CCA is successful.

8. A computer readable storage medium that stores at least one program that, when executed, causes at least one processor to perform operations comprising:
receiving a uplink (UL) grant for a wide band, the wide band i) being wider than a predetermined value, ii) operating on an unlicensed band and iii) including multiple subbands;
measuring channel occupancy for the wide band;
determining whether to generate a medium access control (MAC) protocol data unit (PDU) in units of the whole wide band or in units of subband, based on the measured channel occupancy;
generating the MAC PDU in units of the whole wide band or in units of subband;
performing clear channel assessment (CCA) per subband; and
transmitting the generated MAC PDU via at least one subband where the CCA is successful.

9-18. (canceled)
